(19) United States
(12) Patent Application Publication
(10) Pub. No.: US 2018/0293610 A1
(43) Pub. Date: Oct. 11, 2018

(54) METHODS AND SYSTEMS FOR INTEGRATING APPLICATIONS INTO A CONTENT RECOMMENDATION NETWORK

(71) Applicant: RevContent, LLC, Sarasota, FL (US)

(72) Inventor: Chris Maynard, Sarasota, FL (US)

(73) Assignee: RevContent, LLC, Sarasota, FL (US)

(21) Appl. No.: 15/950,928

(22) Filed: Apr. 11, 2018

Related U.S. Application Data
(60) Provisional application No. 62/484,340, filed on Apr. 11, 2017.

(51) Int. Cl. G06Q 30/02; G06F 9/445

(52) U.S. Cl. CPC G06Q 30/0244; G06F 9/44526; G06Q 30/0276; G06Q 30/0277

(57) ABSTRACT

Aspects of the present disclosure allow for a system of a content recommendation platform that allows developers to create customizable application plug-ins that can be embedded into publisher content and ultimately improve the advertising relevance to readers of a publisher website. The developer-generated application plug-ins may be configured to accept inputs from readers of the publisher website. These inputs may be collected, analyzed, and provide additional insight to advertisers in how to better cater advertising content to the originating publisher website or others with similar characteristics. The content recommendation network may provide an application program interface (API) to subscribed developers and other users, to enable the creation of any and all types of application plug-ins.

### CROSS REFERENCE TO RELATED APPLICATION

This application claims the benefit of U.S. Provisional Application 62/484,340, filed Apr. 11, 2017, and titled, “ METHODS AND SYSTEMS FOR INTEGRATING APPLICATIONS INTO A CONTENT RECOMMENDATION NETWORK,” the disclosure of which is incorporated herein by reference in its entirety and for all purposes.

### TECHNICAL FIELD

The subject matter disclosed herein generally relates to processing data. In some embodiments, the present disclosures relate to methods and apparatuses for integrating applications, or programs generally, into and across a content recommendation network.

### BACKGROUND

In e-marketing and e-commerce, a third party advertising company may assist advertisers in conducting advertising campaigns in publisher digital media. The advertising company may coordinate with advertisers and publishers (e.g., websites) by accepting advertisements and working with publishers to display the advertisements somewhere within the website. An advertising program, called a widget, is placed in the website at a particular location within the website, which contains at least the advertisement and a link that leads out of the publisher website and into a website of the advertiser. The third party advertising company may provide a digital infrastructure for both advertisers and publishers to integrate their content together that benefits both entities, while also providing a back-end or behind the scenes development environment for producing additional content. The development environment may be a part of a suite a functionality that the third party advertising company may provide in a content recommendation network. The publishers and advertisers may subscribe to this content recommendation network in order to access various functionality to assist in ad revenue generation. It is desirable to improve the versatility and functionality of the content recommendation network in order to increase the amount of customization available to subscribers, so that their needs may be better catered to.

### BRIEF SUMMARY

Aspects of the present disclosure are presented for a third party advertising platform in e-commerce and e-marketing providing a development framework that is configured to generate integrated applications and modular programs generally into a content recommendation network.

In some embodiments, the third party advertising platform facilitates the integration of modularized services and features into a content recommendation system. This function of the content recommendation network gives the ability for the third party advertising platform and subscribers to the platform to create applications or other computer programs that tie into the functionality of advertising widgets and are presented in the context of headline and image recommendation widgets. In some embodiments, the content recommendation widgets support these integrations with a flexible container type, allowing the widget to transform to fit functionality, options, and recommendations coming from widget applications. This Widget Application framework creates the structure to support and transport the resulting content recommendations and application features to a publisher's website when the advertising platform ad code is placed on a web page. This structure can be built upon by third parties in the content recommendation network or the third party advertising platform controllers themselves. In some embodiments, publishers have control over which Applications will be used within their widgets, the options of each application, the overall widget itself, and the look and feel of the widget integration into their web pages.

By allowing third parties to add widget apps to the third party advertising platform, the third party is making their app or plugin available for all publishers within the content recommendation system to turn on or off. The widget apps can be integrated deeper within the system as well. Often times, it will be useful for a third party to allow specific settings be controlled by the publisher from within the content recommendation system. For example, a commenting system could have a widget app setting for spam filtering on the comments in the system, controllable from the content recommendation systems display of the widget app settings. Other integrations may allow comments to appear within the content recommendations themselves, all customizable by the publisher through the widget app settings. This flexibility exists within the recommendation.

In some embodiments, a system of a content recommendation network is presented. The system may include: a server comprising a memory and a processor coupled to the memory. The server may be configured to facilitate generation of a plug-in widget app by an advertiser developer. The plug-in widget app may be configured to: be embedded into a publisher website; display an advertisement of the advertiser in the publisher website when embedded; and accept an input from a viewer of the publisher website that is recorded in the system of the content recommendation network while the advertisement is displayed. The server may be further configured to: facilitate quality control of the plug-in widget app; and provide a third party digital marketplace for a plurality of advertisers that did not generate the plug-in widget app to use the plug-in widget app in other publisher websites.

In some embodiments of the system, the plug-in widget app is further configured to access a portion of a second plug-in and display at least a portion of the second plug-in as part of the display of the first plug-in widget app.

In some embodiments of the system,the plug-in widget app includes a commenting functionality configured to facilitate generation of viewer comments on the publisher website, and transmit, to the system of the content recommendation network, data associated with the comments. In some embodiments of the system, the server is further configured to improve ad revenue generation based on the received data associated with the comments from the plug-in widget app.

### BRIEF DESCRIPTION OF THE DRAWINGS

Some embodiments are illustrated by way of example and not limitation in the figures of the accompanying drawings.

FIG. 1 is a network diagram illustrating an example network environment suitable for performing aspects of the present disclosure, according to some embodiments.

FIG. 2 illustrates the user flow for a web page displaying content recommendations and a commenting system, according to some embodiments.

FIG. 3 illustrates a widget app store within a content recommendation system, according to some embodiments.

FIG. 4 depicts a content recommendation widget with a commenting system plugin enabled, according to some embodiments.

FIG. 5 illustrates widget settings within a content recommendation platform, according to some embodiments.

FIG. 6 illustrates a widget app that integrates third party commenting systems into the widget settings from a content recommendation network, according to some embodiments.

FIG. 7 illustrates the settings from a third party commenting system being presented as widget app settings in a content recommendation network, according to some embodiments.

FIGS. 8A and 8B illustrate an example of a development environment used to generate one or more of the plug-in widgets, according to some embodiments.

FIG. 9 illustrates a flowchart showing an example methodology for developing and integrating third party commenting systems from the content recommendation network, according to some embodiments.

FIG. 10 is a block diagram illustrating components of a machine, according to some example embodiments, able to read instructions from a machine-readable medium and perform any one or more of the methodologies discussed herein.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Systems, methods, and apparatuses are presented for a third party advertising platform in e-commerce or e-marketing to enable an advertiser or a publisher to customize where advertisements are to appear on the publisher's website in e-commerce and e-marketing. Typically, a third party advertising company coordinates with advertisers and publishers (e.g., websites) by accepting advertisements and working with publishers to display the advertisements somewhere within the website. An advertising program, called a widget, is placed in the website at a particular location within the website, which contains at least the advertisement and a link that leads out of the publisher website and into a website of the advertiser. Conventionally, the third party advertising company can allow a limited degree of maneuverability on the part of the advertisers to specify where or on what websites their advertisements should be displayed. For example, conventionally, the advertisers may specify that their ads should be displayed on websites having a general type of subject matter, such as blogs related to food or websites related to travel. In other cases, conventionally, the advertisers may be able to place bids to compete for where they would like their advertisements to be placed. Conventionally, the advertiser must work with the third party advertising company, who then reconfigures one or more widgets to accommodate the desires of the advertiser.

Aspects of the present disclosure allow for a system of a content recommendation platform that allows developers to create customizable application plug-ins that can be embedded into publisher content and ultimately improve the advertising relevance to readers of a publisher website. The developer-generated application plug-ins may be configured to accept inputs from readers of the publisher website. These inputs may be collected, analyzed, and provide additional insight to advertisers in how to better cater advertising content to the originating publisher website or others with similar characteristics. The content recommendation network may provide an application program interface (API) to subscribed developers and other users, to enable the creation of any and all types of application plug-ins.

In some embodiments, the plug-ins, once generated, may be reused by other advertisers, publishers, or other subscribers in the content recommendation network. The plug-ins may perform the same types of operations.

In some embodiments, a first plug-in developed in the content recommendation platform may be configured to access a portion of a second plug-in and display at least a portion of the second plug-in as part of the display of the first plug-in. In general, the first plug-in may utilize a portion of the functionality of the second-plug in.

In some embodiments, for all cases, the plug-ins developed in the content recommendation network may be connected to a revenue generating plug-in so that each plug-in contributes to generating more revenue for the entities involved.

An example of a plug-in that may be produced by the content recommendation includes a commenting plug-in that is configured to record an amount of activity in the comments, type of comments, and/or level of interaction by a particular user. Another example may be a polling plug-in that can be used to generate any type of poll, and may be configured to record an amount of activity expressed as a number of votes, strength of one position over another, and/or level of interaction by a particular user.

Currently, website publishers looking to monetize or engage their audiences are met with an abundance of services all competing for website real estate. The content recommendation platform that allows for the generation of the plug-in Widget Applications consolidates the integrations, allowing publishers a simplified way to manage, track and customize through a standardized framework which reduces service calls for integration. Case in point is third party commenting systems commonly integrated near the bottom of articles. This same location is often where a content recommendation widget will be place, referred to as below article. A commenting system can be integrated as a widget application in a number of ways, as described more below. Once integrated with a content recommendation system, the settings for the comment plugin may be managed from either tool's administration interface, but having one place to manage both recommendations and plugins is convenient for a publisher.

Although there is no limitation to the types of services that may be integrated as widget apps into a content recommendation system, in some embodiments, an approval process may be conducted by the controllers of the third party advertising platform and/or an integration period if system changes are required by either party.

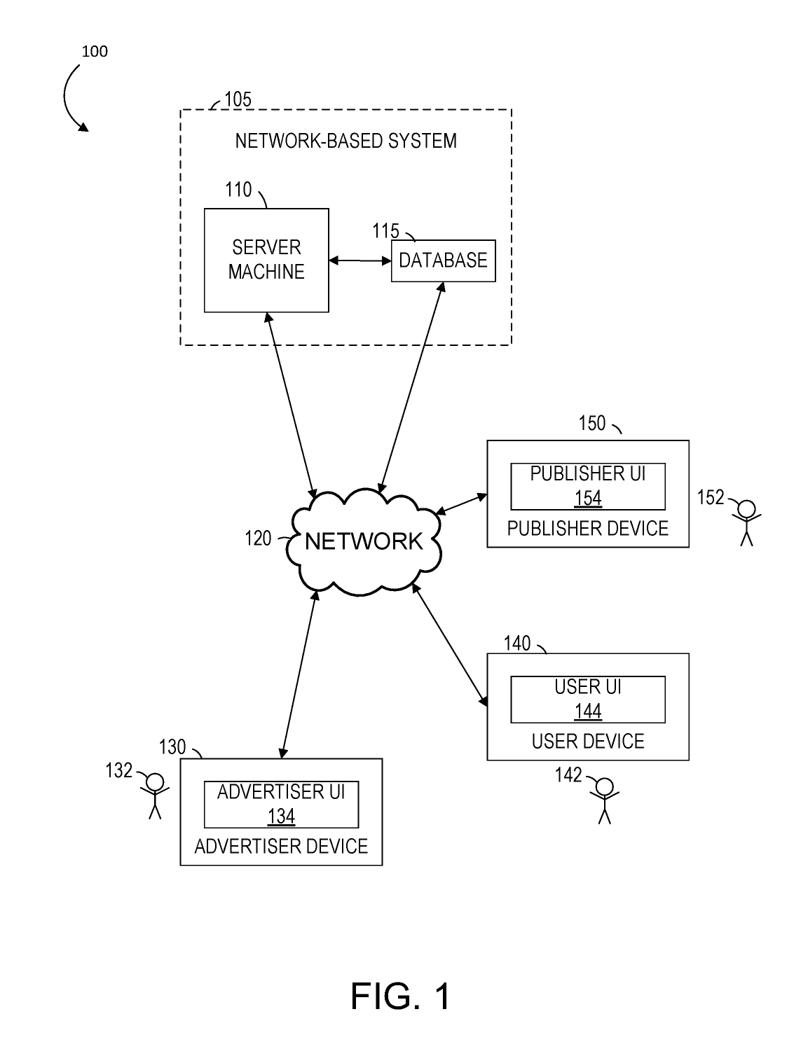

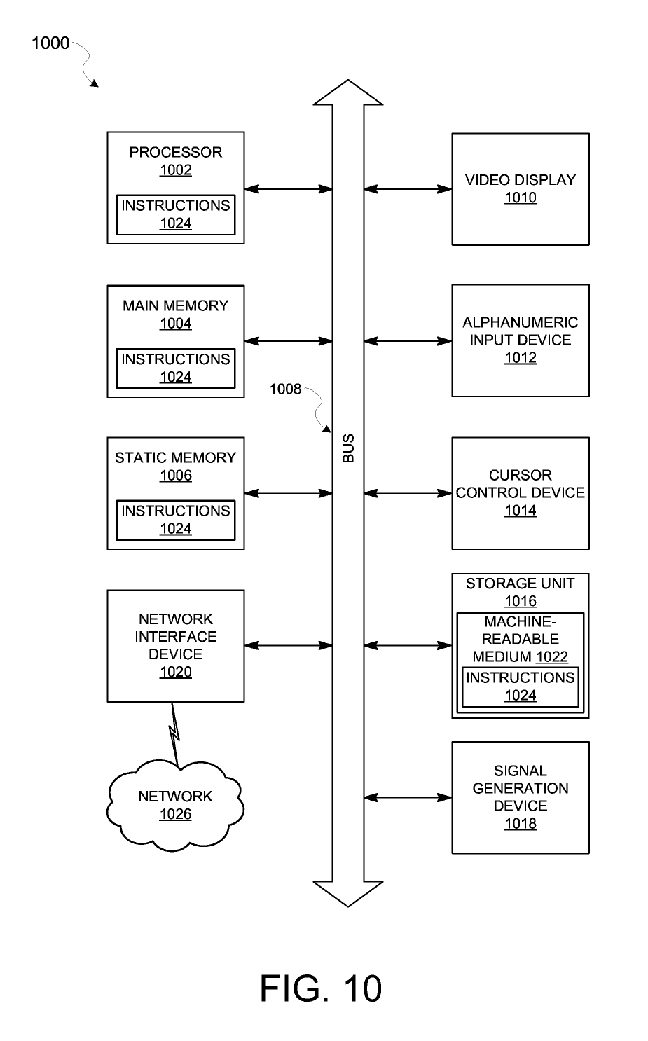

Referring to FIG. 1, a network diagram illustrating an example network environment 100 suitable for performing aspects of the present disclosure is shown, according to some embodiments. The example network environment 100 includes a server machine 110 and a database 115 of a network-based system 105 of a third-party advertising platform, an advertiser device 130 for an advertiser user 132, a user device 140 for a user 142 who accesses websites on the Internet, and a publisher device 150 for a publisher user 152 who publishes websites, all communicatively coupled to each other via a network 120. The server machine 110 may be implemented by a physical server machine, a virtual server machine, or a combination of the two. may form all or part of a network-based system 105 (e.g., a cloud-based server system configured to provide one or more services to the advertiser device 130, user device 140 and publisher device 140). The network-based system 105 may be configured to facilitate advertisement placements by advertisers, such as advertiser user 132, onto websites of publishers, such as publisher user 152. The server machine 110, the advertiser device 130, the user device 140, and the publisher device 150 may each be implemented in a computer system, in whole or in part, as described below with respect to FIG. 10.

Also shown in FIG. 1 are the advertiser user 132, the website user 142, and the publisher user 152. One or more of the users 132, 142, and 152 may be a human user, a machine user (e.g., a computer configured by a software program to interact with the advertiser device 130), or any suitable combination thereof (e.g., a human assisted by a machine or a machine supervised by a human). The advertiser user 132 may be associated with the advertiser device 130 and may be a user of the advertiser device 130. For example, the advertiser device 130 may be a desktop computer, a vehicle computer, a tablet computer, a navigational device, a portable media device, a smartphone, or a wearable device (e.g., a smart watch or smart glasses) belonging to the first user 132. Likewise, the website user 142 may be associated with the user device 140, and the publisher user 152 may be associated with the publisher device 150. The advertiser user 132 may desire to place advertisements for e-marketing in various websites of various publishers that are likely to generate web traffic to associated advertiser websites. The user 142 may be an entity that accesses content on a publisher user 152 website, who may be a target audience of the advertiser user 132. The publisher user 152 may be an entity who generates one or more websites that provide content for users 142, and who may generate revenue by allowing advertisers to pay for placing their advertisements on the publisher website(s). As previously discussed, the network-based system 105 may be operated by a third-party advertising company that helps facilitate the ad placement of the advertiser users 132 onto publisher websites.

In some embodiments, the devices 130, 140, and 150 may be configured to display user interfaces that are coupled to the network 120. For example, the advertiser device 130 may be configured to display and operate an advertiser user interface (UI) 134, the user device 140 may be configured to display and operate an affiliate UI 144, and the publisher device 150 may be configured to display and operate an admin UI 154. The Uls 134, 144, and 154 may be configured to receive inputs from a user, such as users 132, 142, and 152, respectively.

Any of the machines, databases 115, advertiser device 130, user device 140 or publisher device 150 shown in FIG. 1 may be implemented in a general-purpose computer modified (e.g., configured or programmed) by software (e.g., one or more software modules) to be a special-purpose computer to perform one or more of the functions described herein for that machine, database 115, or devices 130, 140, and 150. For example, a computer system able to implement any one or more of the methodologies described herein is discussed below with respect to FIG. 10. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 120 may be any network that enables communication between or among machines, databases 115, and devices (e.g., the server machine 110 and the devices 130, 140, and 150). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof. Accordingly, the network 120 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 120 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

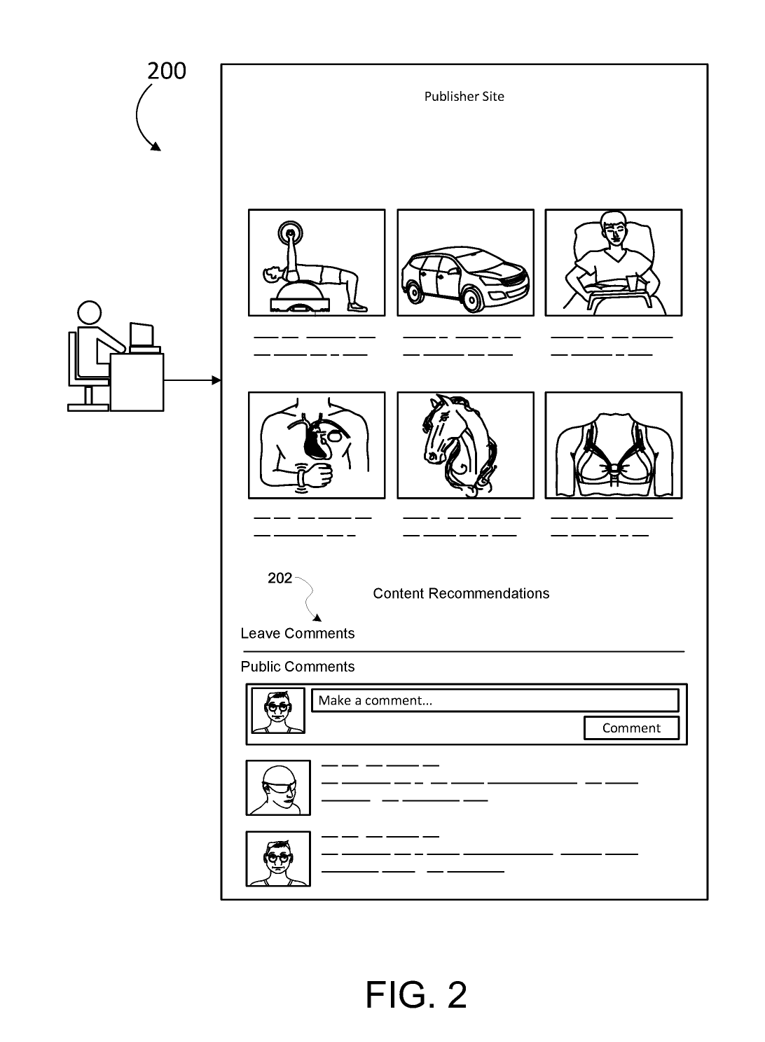

Referring to FIG. 2, illustration 200 shows the user flow for a web page displaying content recommendations and a commenting system 202 as one example of a plug-in application, according to some embodiments. From a functional perspective of the reader of the web page, the commenting system 202 may appear to be like any other commenting section of a web page. However, the commenting system 202 here is a plug-in widget developed by the third party advertising development platform. Within the descriptions of this disclosure, the commenting system would be a widget plug-in app within the content recommendation widget. Because the commenting system is derived from the content recommendation network, certain aspects of the data generated in the commenting system 202, such as the number of comments, what users generated comments, and in some cases the type of comments, may be recorded in the content recommendation network and used to improve the relevance of advertisements. In general, the functionality of the content recommendations contained in the web page may be derived in part from the content recommendation network, and may involve interactions between multiple widgets originating from different content recommendation entities, e.g., different advertisers.

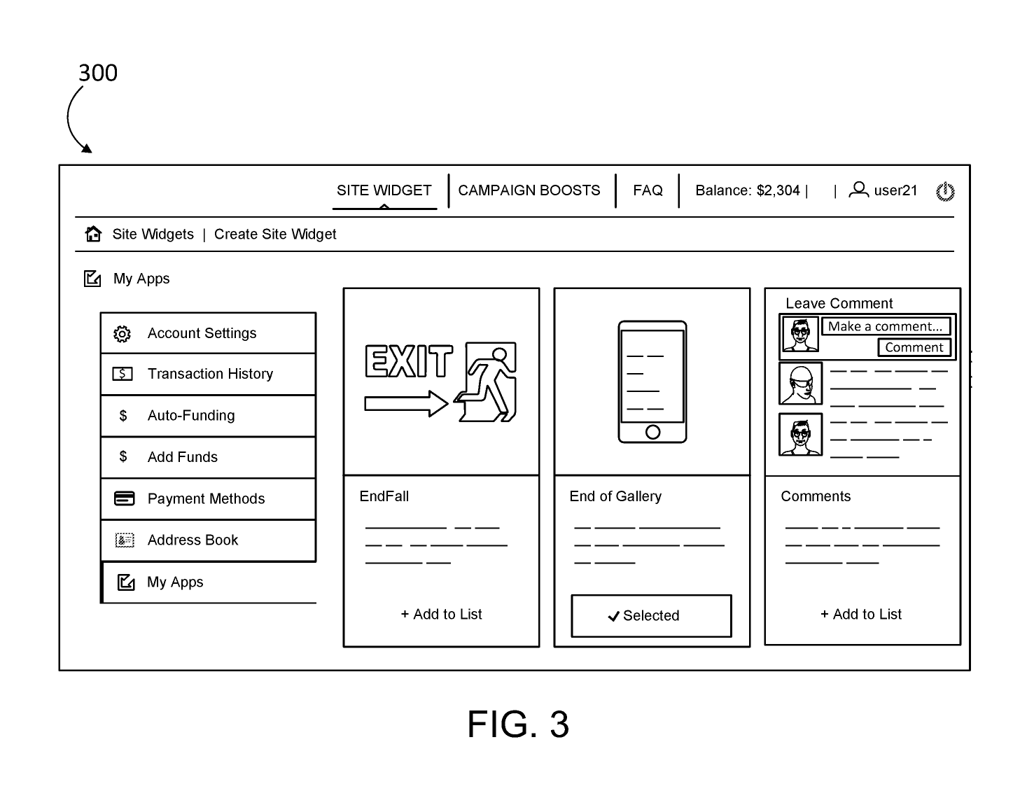

Referring to FIG. 3, illustration 300 shows an example of a widget app store within a content recommendation network, according to some embodiments. Here, multiple plug-in applications that are generated by the development platform, like the commenting system 202 (see FIG. 2), may be displayed for other advertisers and publishers to buy and reuse. The developer may receive royalties for each time the plug-in application is purchased by other subscribers to the content recommendation network. Then, the other subscribers may utilize that plug-in widget to embed the application as part of their advertisements in a publisher website. The publisher may still be in control of the placement of the widgets, in some embodiments.

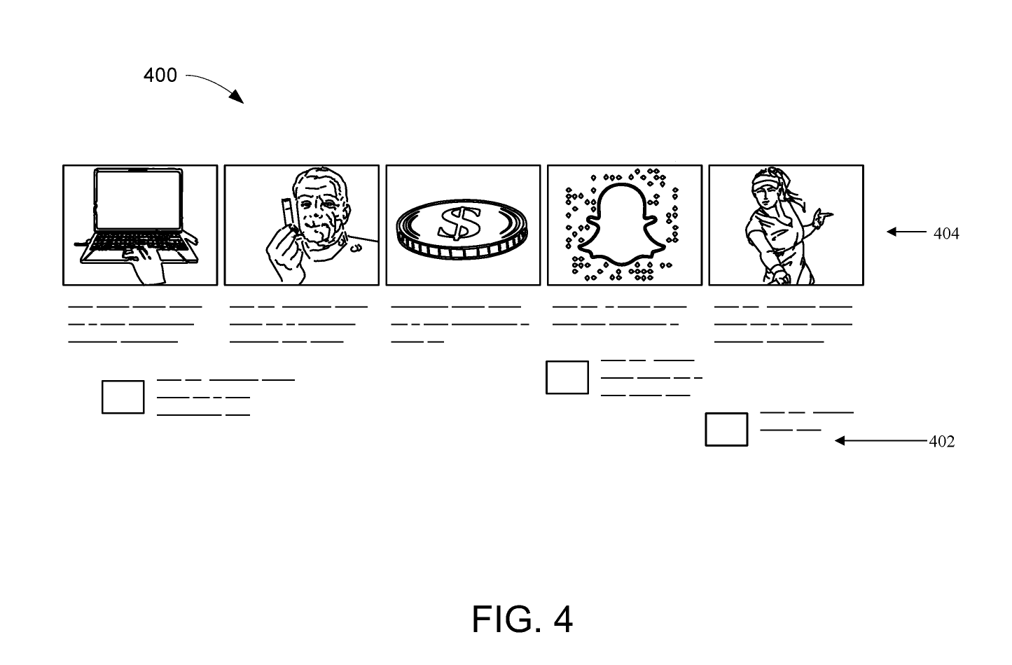

Illustration 400 of FIG. 4 depicts a content recommendation widget with a commenting system plugin enabled, according to some embodiments. In this example, this widget app displays comments 402 below each content recommendation panel 404, and these panels are of a flexible container type, where if the comment is available from the third party, then it would show seamlessly as part of the recommendation widget. The comments 402 under each picture may be real comments existing on the web page that the user is led to if that picture 404 is selected. Commenting plugins integrated into publisher's sites often times have their own algorithm for figuring out the order of comments as displayed to the user. The content recommendation system may or may not have any option on which comment the third parties are providing for display within the widget. This particular widget app exposes that top comment for a URL that content recommendation system reads in and then displays alongside normal content recommendations. The comment that is displayed within the widget, inside the flexible container for the panel, links to the destination URL. This destination URL may or may not show the same comment below the content within the commenting system plugin.

Thus, illustration 400 shows an example of how a second developed plug-in application may be designed to incorporate at least partial content of a first developed plug-in application, and the combination may be used as a single widget into a publisher website. The publisher enables this particular widget app from within their settings in the content recommendation platform, in some embodiments. It is noted that the embedded plug-in applications described herein are possible because the multiple plug-in applications may be developed in the same development platform of the present disclosures. In contrast, advertising widgets of other content recommendation networks that show only the pictures leading to different content may not have the capability of embedding the comments sections due to the commenting system being generated by a separate developer or network.

One simple and common approach for a commenting system is to have content recommendations above the commenting plugin itself. By making use of content recommendation feeds, these commenting systems have control over the recommendation platform being used. With a widget app, the publisher has the opposite control over the commenting plugin from within the content recommendation system application. Commenting systems are widget apps within the content recommendation system. A publisher can select the commenting system they would like to use and place the recommendation widget into their site. The recommendation widget will handle any authorization and service calls it needs to make to integrate the commenting system within the publisher's pages, according to some embodiments. A typical setup would be a content recommendation on top with comments below it as depicted in FIG. 2.

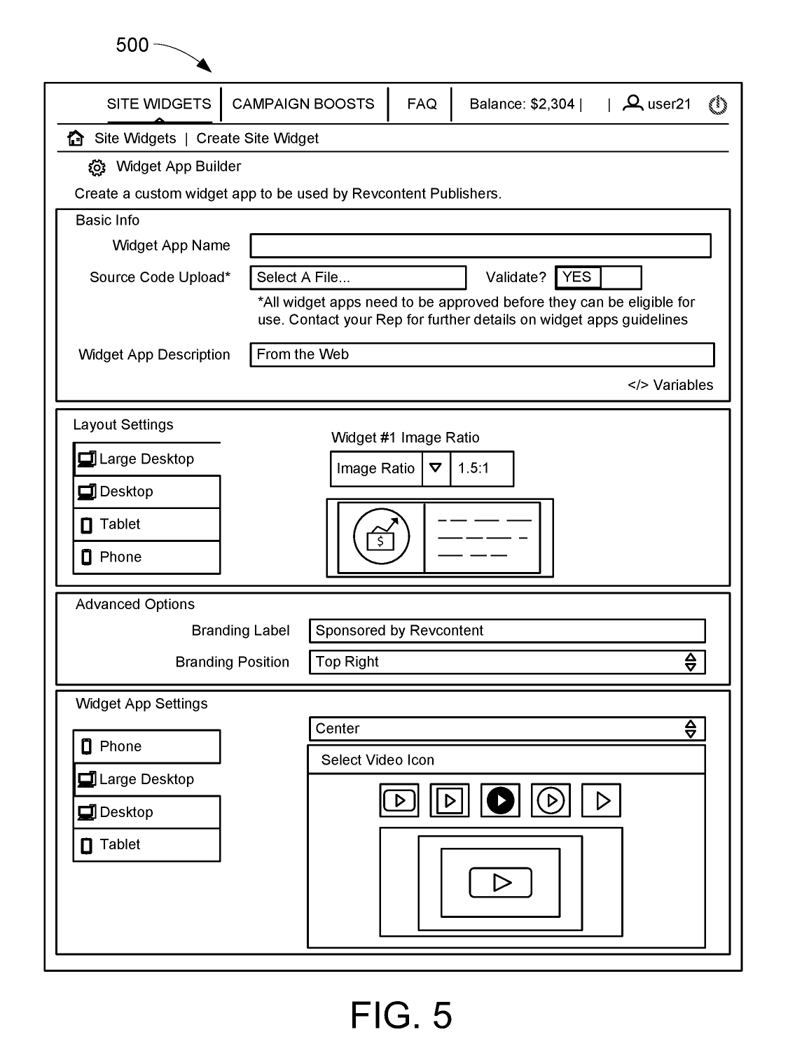

Illustration 500 of FIG. 5 illustrates widget settings within a content recommendation platform, according to some embodiments. Part of the settings allows the user to enable/disable and customize widget apps on a per widget basis. As some examples, shown here are settings about the layout, advanced options, and settings for the widget apps, both generally and individually. These settings allow for a degree of customization, particularly among widget apps that may be reused by multiple advertisers or publishers. These options provide one example of how a user in the content recommendation platform may access a widget app of either their own design or the design of another, and integrate the widget app into a widget of the content recommendation platform that is uploaded to a publisher website (see e.g., FIGS. 2, 3).

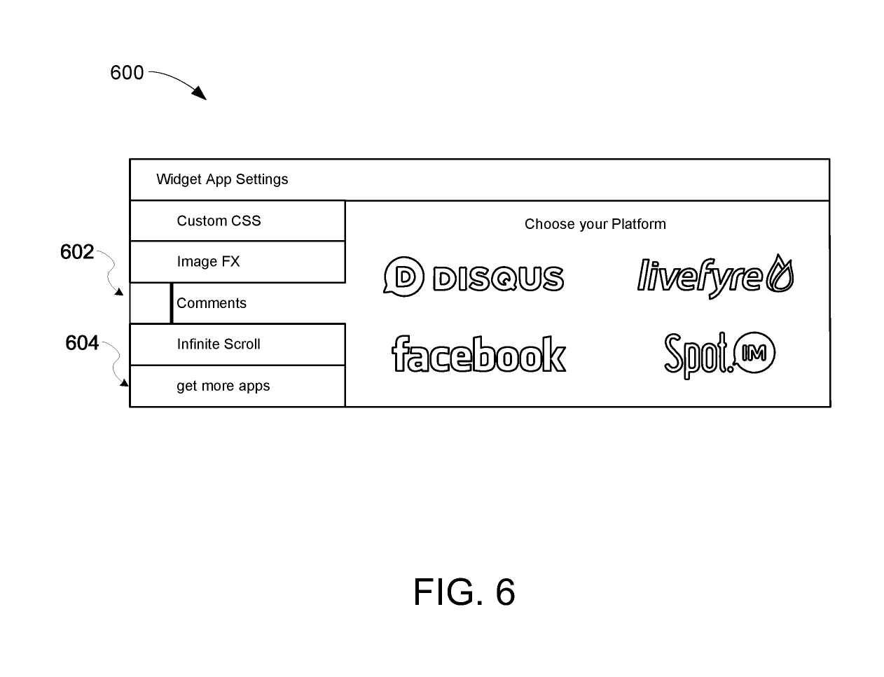

Illustration 600 of FIG. 6 illustrates a widget app that integrates third party commenting systems into the widget settings from a content recommendation network. In this example, the first widget app may be configured to integrate a second widget app, in the form of a commenting system. The first widget app may be configured to accommodate multiple types of commenting systems, where four examples are shown here, provided in the comments tab 602. Embedding the second app into the first is configurable in the settings, as an example.

In other cases, other kinds of plug-in widget apps may be integrated. For example, polling applications may be integrated to a content recommendation panel. The user may review other widget apps to integrate by selecting the tab 604 called “get more apps,” as an example. As another example, the polling application may be integrated into a large advertisement that surrounds the webpage content.

In general, the first widget app may be owned and controlled by a first advertiser, while the second widget app maybe owned and controlled by a second advertiser. In the content recommendation platform, the advertisers may be allowed to select different widget apps made by different companies and integrate them into their own widget apps for greater functionality and flexibility. Thus, the forum in the content recommendation network may act as a sort of marketplace or collaboration space for advertisers to combine multiple widget apps together.

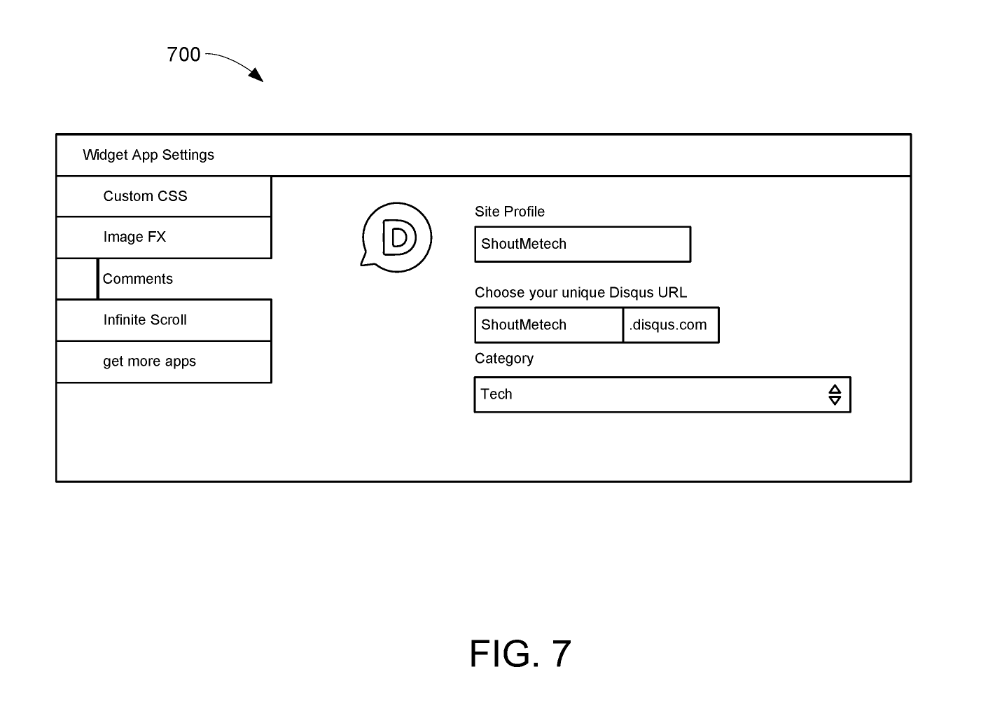

Illustration 700 of FIG. 7 illustrates the settings from a third party commenting system being presented as widget app settings in a content recommendation platform, according to some embodiments. From the example in FIG. 6, the third party commenting system Disqus®, once selected, as shown may include specific types of settings that may be configurable. In this case, the settings provide for unique URLs to link to the comments specific to the third party commenting system.

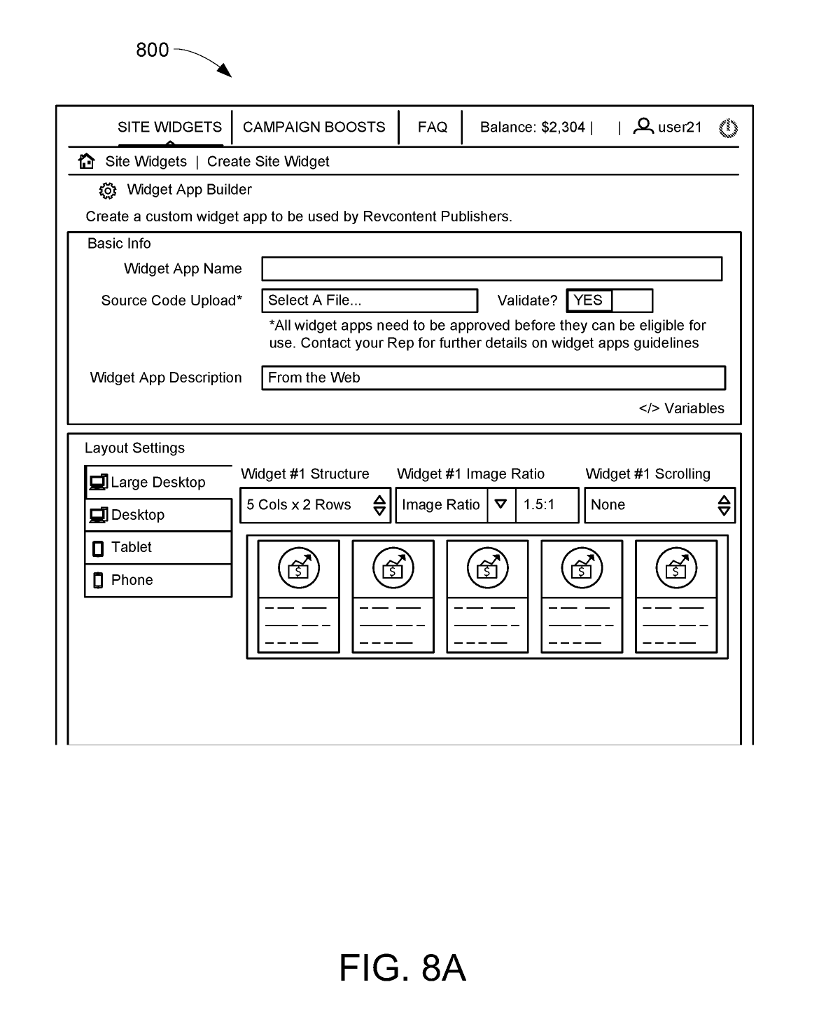

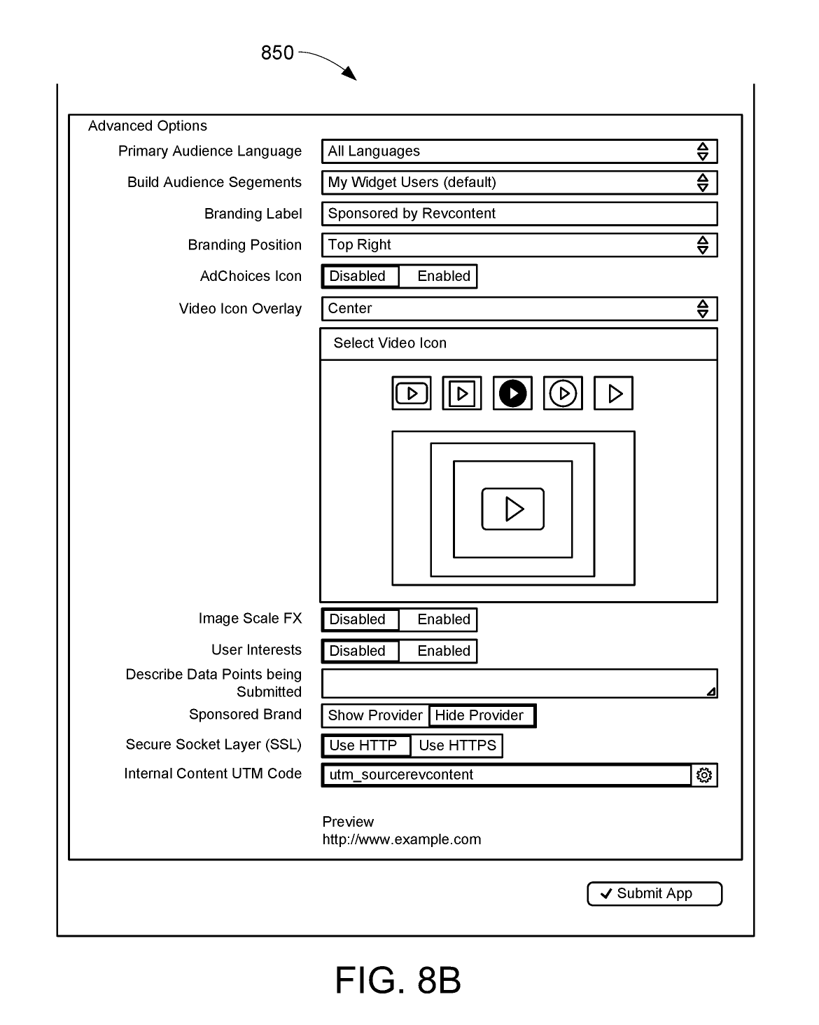

Referring to FIGS. 8A and 8B, shown is an example of a portion of a development environment used to generate one or more of the plug-in widgets, according to some embodiments. FIG. 8A shows a top portion 800 of the example development environment. In some embodiments, this display applet allows a user to submit source code related to any plug-in widget app. This code may be presented in a digital store or marketplace that can be utilized by other advertisers to allow them to also embed the same plug-in widget app into their widgets or other advertisements. In some embodiments, additional options include allowing a programmer to specify how the plug-in widget may be formatted or structured to look in a publisher website. For example, the widget app can be part of a structure that shows five different panels in a row, where each panel shows a different widget app. Other options include allowing for different languages, allowing for different positions within a publisher website, whether the widget app can be overlaid, and so on. In FIG. 8B, the bottom portion 850 is shown as a continued example of the development environment. Here, a number of advanced options are shown for how the widget app can be configured, and where it may appear or be embedded within another widget app.

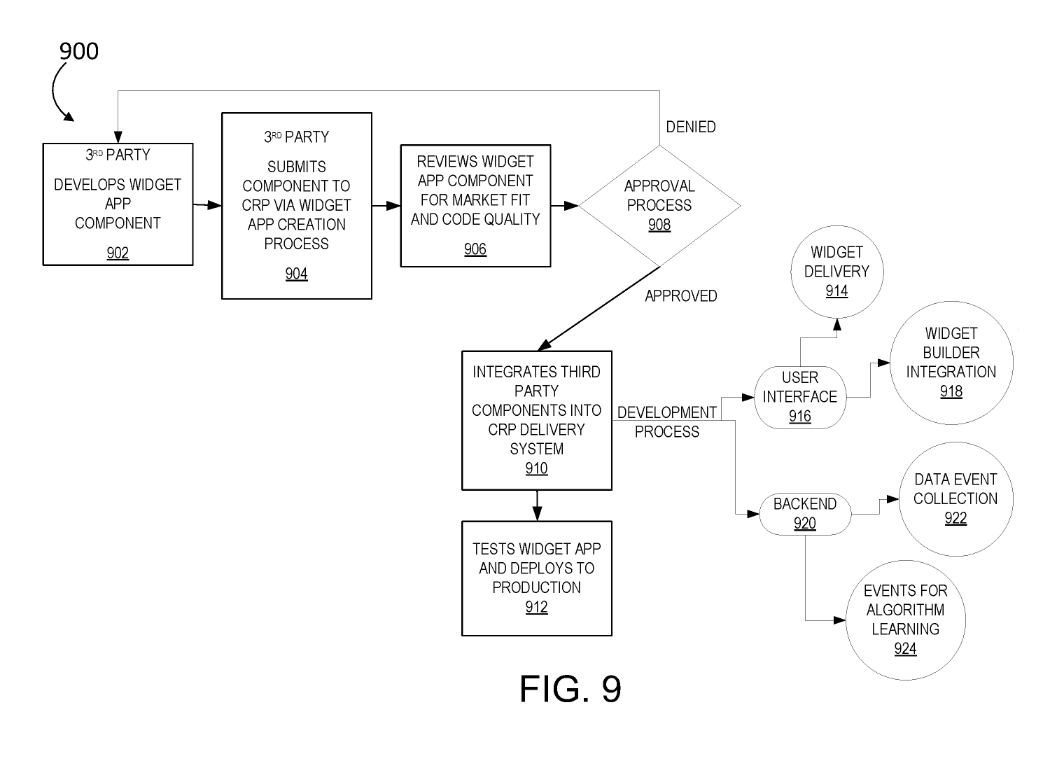

Referring to FIG. 9, illustration 900 shows a flowchart showing an example methodology for developing and integrating third party commenting systems from the content recommendation network, according to some embodiments. As shown, the example methodology includes a cyclical process for developing the widget app that the third party content recommendation system will facilitate. At block 902, a third party developed a widget app component that may be used to provide specific functionality when embedded into a publisher website. Examples include a commenting app, a polling app, a counting app, or a graphical user interface app. At block 904, the third party submits the widget app component to the content recommendation platform (CRP) via a widget app creation process, for integration into the content recommendation network. Examples of this development include utilizing the development environment example in FIGS. 8A and 8B. At block 906, the content recommendation platform may facilitate a review of the widget app component for market fit and code quality. This may be performed in part by people assessing the nature and quality of the widget app, using user interfaces in the content recommendation platform.

An approval process 908 is also provided, and once approved, the plug-in widget app may be integrated in a delivery system of the third party content recommendation system. If the widget app is denied, the cycle may proceed back to step 902, where the third party may revise the widget app or work on developing a new one. The digital marketplace or digital store is also controlled by the third party content recommendation network, and it allows for other advertisers and developers to make use of the developed plug-in widget app. If approved, at block 910, the content recommendation platform may be configured to integrate the third party widget app component into the content recommendation delivery system. At block 912, the widget app may be tested in a delivery environment to see how the widget app performs in practical use, for example in a live website. The act of deploying the widget app into a test website is evaluated, to ensure the widget app and its delivery into a website is reliable.

A development process of the widget app into publisher websites is initiated after the widget app is integrated into the content recommendation platform. The widget app will be available for selection in a user interface 916 of the content recommendation platform (see e.g., FIG. 3), which will also allow for the widget to be delivered to publisher websites that the advertiser user will display their ads in, at step 914. Additionally, the widget app may be further integrated into other widget apps, and then the embedded package may be ultimately deployed to a publisher website, starting at step 918 (see e.g., FIG. 4). The widget app may also be used in the backend processes that are also supported by the content recommendation platform, at block 920. Once the widget app is deployed in a publisher website, viewer data generated by the widget app may be received at the backend of the third party content recommendation network. This data may be used to better determine the types of patterns and behaviors that may allow for improved refinement and selection of what widget apps or advertisements may be better suited to groups of viewers or particular viewers specifically. This includes data event collection 922 and data to support events for algorithm learning 924.

The content recommendation network may be configured to integrate the developed widgets into the content recommendation network in one or more particular ways, depending on the type of widget that has been generated. For example, the third party widget may be represented as part of an application user interface (UI). The third party widget may be represented in the UI as a widget setting, where options of the integration are presented to the publisher for configuration. There may be APIs that communicate settings between services as well.

As another example, the third party widget may be integrated into the content recommendation network as part of delivery into a publisher website. The presentation of the third party app may depend on what it is, but modifications may be made to the content recommendation network to support the application. If the app is loaded in an iframe then there is very little customization to be made, according to some embodiments.

In the instances where a third party widget is designed to cause a visual effect, such as causing display of an advertisement in a publisher website or providing additional functionality in the publisher website, the content recommendation network may facilitate integration of the third party widget using the application UI, according to some embodiments. Changes may be stored in a data store of the content recommendation network, the changes of which are then communicated to the third party via API. These setting changes may be pushed by the content recommendation platform to the third party's API endpoint or pulled by the third party from an endpoint that is provided by the content recommendation platform.

As a third example, the third party widget may be configured to provide reporting data from the publisher website. Depending on the application, data may be pulled about the performance of the plugin via the third parties API and that data may be brought back to the content recommendation UI application.

In some embodiments, particular updates are provided to the content recommendation platform in order to enable a subscriber to utilize somebody else's third party widget. For example, a POLL application would be turned on/off by the user in the content recommendation platform UI. The user, such as another advertiser, would then enter the details of what the poll question is and the possible answers for the poll itself via the application UI. This data would be stored in a database of the content recommendation platform, and a process that is running every 10 minutes would pick up on the change and push the settings of this poll to the third party. The third party will receive these updates, in this case the creation of a poll, its question and options in the form of an API call. Once registered with the third party, a poll ID would be returned back to the other advertiser user. This poll ID would be stored in the content recommendation platform and any other information required to render the third party's poll “widget.” This configuration data would be pushed to the delivery system and the delivery code would see the setting for the poll as enabled, and inject the correct configuration code to invoke the third party widget into the content recommendation widget.

This also illustrates an example of how a third party widget is integrated into the widget of the content recommendation platform, that ultimately gets uploaded onto a publisher website as an integrated package. In some embodiments, this principle can also be extended to allow a first third-party widget to be integrated into a second third-party widget, the totality of which may then be integrated into the content recommendation widget that is uploaded onto the publisher website. The example of the POLL application may be extended to allow for integration of the first third-party widget into the second third-party widget. In other cases, the control of any secondary plugin in a third party widget may or may not have its configuration also handled in the same way as the settings are described above. In some cases, the third party themselves will handle the configuration of the secondary plugin entirely. In other cases, these controls would be exposed by the third party and set in the above fashion. In the final case, the secondary plugins settings, configuration, and stats would be handled by directly communicating with this secondary third-party altogether. The communications of which may be facilitated by the content recommendation platform.

Referring to FIG. 10, the block diagram illustrates components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine 110 or a client machine in a server-client network environment, or as a peer machine in a distributed (e.g., peer-to-peer) network environment. The machine 1000 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine 1000 is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a video display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, a signal generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein, including, for example, any of the descriptions of FIGS. 2-9. The instructions 1024 may also reside, completely or at least partially, within the main memory 1004, within the processor 1002 (e.g., within the processor's cache memory), or both, before or during execution thereof by the machine 1000. The instructions 1024 may also reside in the static memory 1006.

Accordingly, the main memory 1004 and the processor 1002 may be considered machine-readable media 1022 (e.g., tangible and non-transitory machine-readable media). The instructions 1024 may be transmitted or received over a network 1026 via the network interface device 1020. For example, the network interface device 1020 may communicate the instructions 1024 using any one or more transfer protocols (e.g., HTTP). The machine 1000 may also represent example means for performing any of the functions described herein, including the processes described in FIGS. 2-9.

In some example embodiments, the machine 1000 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1022 able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database 115, or associated caches and servers) able to store instructions 1024. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device such as machines 110, 130, 140, or 150, as well as cloud-based storage systems or storage networks that include multiple storage apparatus or devices such as machines 110, 130, 140 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1022 is non-transitory in that it does not embody a propagating signal. However, labeling the tangible machine-readable medium 1022 as “non-transitory” should not be construed to mean that the medium is incapable of movement; the medium should be considered as being transportable from one physical location to another. Additionally, since the machine-readable medium 1022 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1022 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1002 or a group of processors 1002) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1002 or other programmable processor 1002. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1008) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1002 that are temporarily configured (e.g., by software) or permanently configured to perform the relevant operations. Whether temporarily or permanently configured, such processors 1002 may constitute processor-implemented modules that operate to perform one or more operations or functions described herein. As used herein, “processor-implemented module” refers to a hardware module implemented using one or more processors 1002.

Similarly, the methods described herein may be at least partially processor-implemented, a processor 1002 being an example of hardware. For example, at least some of the operations of a method may be performed by one or more processors 1002 or processor-implemented modules. As used herein, “processor-implemented module” refers to a hardware module in which the hardware includes one or more processors 1002. Moreover, the one or more processors 1002 may also operate to support performance of the relevant operations in a “cloud computing” environment or as a “software as a service” (SaaS). For example, at least some of the operations may be performed by a group of computers (as examples of machines 1000 including processors 1002), with these operations being accessible via a network 1026 (e.g., the Internet) and via one or more appropriate interfaces (e.g., an API).

The performance of certain operations may be distributed among the one or more processors 1002, not only residing within a single machine 1000, but deployed across a number of machines 1000. In some example embodiments, the one or more processors 1002 or processor-implemented modules may be located in a single geographic location (e.g., within a home environment, an office environment, or a server farm). In other example embodiments, the one or more processors 1002 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 1000 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A system of a content recommendation network comprising:
a server comprising a memory and a processor coupled to the memory;
the server configured to:
facilitate generation of a plug-in widget app by an advertiser developer, the plug-in widget app configured to:
be embedded into a publisher website;
display an advertisement of the advertiser in the publisher website when embedded; and
accept an input from a viewer of the publisher website that is recorded in the system of the content recommendation network while the advertisement is displayed;
facilitate quality control of the plug-in widget app; and
provide a third party digital marketplace for a plurality of advertisers that did not generate the plug-in widget app to use the plug-in widget app in other publisher websites.

2. The system of claim 1, wherein the plug-in widget app is further configured to access a portion of a second plug-in and display at least a portion of the second plug-in as part of the display of the first plug-in widget app.

3. The system of claim 1, wherein the plug-in widget app comprises a commenting functionality configured to facilitate generation of viewer comments on the publisher website, and transmit, to the system of the content recommendation network, data associated with the comments.

4. The system of claim 3, wherein the server is further configured to improve ad revenue generation based on the received data associated with the comments from the plug-in widget app.

5. A non transitory computer readable medium comprising instructions that, when interpreted by a processor, cause a machine to perform operations comprising:
facilitating generation of a plug-in widget app by an advertiser developer, the plug-in widget app configured to:
be embedded into a publisher website;
display an advertisement of the advertiser in the publisher website when embedded; and
accept an input from a viewer of the publisher website that is recorded in the system of the content recommendation network while the advertisement is displayed;
facilitating quality control of the plug-in widget app; and
providing a third party digital marketplace for a plurality of advertisers that did not generate the plug-in widget app to use the plug-in widget app in other publisher websites.

6. The computer readable medium of claim 5, wherein the plug-in widget app is further configured to access a portion of a second plug-in and display at least a portion of the second plug-in as part of the display of the first plug-in widget app.

7. The computer readable medium of claim 6, wherein the plug-in widget app comprises a commenting functionality configured to facilitate generation of viewer comments on the publisher website, and transmit, to the system of the content recommendation network, data associated with the comments.

8. The computer readable medium of claim 7, wherein the server is further configured to improve ad revenue generation based on the received data associated with the comments from the plug-in widget app.

9. A method of a server of a content recommendation network, the method comprising:
facilitating generation of a plug-in widget app by an advertiser developer, the plug-in widget app configured to:
be embedded into a publisher website;
display an advertisement of the advertiser in the publisher website when embedded; and
accept an input from a viewer of the publisher website that is recorded in the system of the content recommendation network while the advertisement is displayed;
facilitating quality control of the plug-in widget app; and
providing a third party digital marketplace for a plurality of advertisers that did not generate the plug-in widget app to use the plug-in widget app in other publisher websites.

10. The method of claim 9, wherein the plug-in widget app is further configured to access a portion of a second plug-in and display at least a portion of the second plug-in as part of the display of the first plug-in widget app.

11. The method of claim 9, wherein the plug-in widget app comprises a commenting functionality configured to facilitate generation of viewer comments on the publisher website, and transmit, to the system of the content recommendation network, data associated with the comments.

12. The method of claim 11, further comprising improving ad revenue generation based on the received data associated with the comments from the plug-in widget app.
